(19) United States
(12) Patent Application Publication
(10) Pub. No.: US 2007/0005408 A1
(43) Pub. Date: Jan. 4, 2007

(54) Method and structure for agenda based scheduling using sub-events with automated management functions

(75) Inventors: Greg Boss, American Fork, UT (US); Andrew Richard Jones, Round Rock, TX (US); Kevin C. McConnell, Austin, TX (US); Chanh V. Nguyen, Raleigh, NC (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/170,439

(22) Filed: Jun. 30, 2005

(51) Int. Cl. G06F 9/46

(52) U.S. Cl. 705/8

(57) ABSTRACT

A method (and structure) of electronically scheduling an event comprising one or more sub-events. An event agenda is generated for the event by identifying a sub-event agenda item for each sub-event. Each sub-event agenda item can be entered into an electronic calendar scheduler as a separately-scheduled sub-event for the event.

### BACKGROUND OF THE INVENTION

1. Field of the Invention

The present invention generally relates to a system and method for creating calendar events with logical sub-events such that invitees can accept or decline each sub-event individually, thereby providing for a more finely-tuned control of the calendar and supports real scenarios not currently possible. The system further allows for automated sub-event management controls to the meeting owner, such as notifying required and optional invitees of sub-event (agenda) changes within the overall meeting, using any of possible communication means such as Instant Messaging, Short Message Service (SMS), Automated dial-out functions, and email.

2. Description of the Related Art

It is common in the business world to be involved in all-day meetings or meetings that last several hours. Meetings of these types almost always involve a detailed agenda and many people.

These types of meetings will also typically involve primary participation from different people throughout different portions of the agenda. However, meetings do not have to last several hours to inherit these properties. For example, many one-hour meetings are divided up into 10- or 15-minute events with different presenters and key stakeholders.

These types of meetings are usually posted to an individual's calendar or the group's calendar as a single event, such as, for instance, a meeting scheduled to occur from 8 A.M. to 5 P.M.

In most cases, however, individuals may be interested in or required to attend only certain parts of the meeting. By using a single event to represent the meeting, a number of calendaring problems can arise.

For example, a lengthy meeting event will block the attendees' entire day, limiting the usefulness of the electronic calendar for scheduling other events. In a scenario in which an attendee needs to be present only for 30 minutes of a 4-hour meeting, the remaining 3½ hours of his calendar appear booked to others (e.g., co-workers, secretaries, assistants, etc.). Therefore, using existing tools, scheduling during that time is not available.

The only real work-around for this problem known to the present inventors is to double-book entries in the calendar. This method requires intimate knowledge of the meetings already on the calendar. Often, this type of information is confidential or simply not available to interested third parties.

Further, for those that do have access to this information, such as a secretary or assistant, the process of obtaining that information can be a significant and time consuming task. For those without intimate knowledge of the calendar details, there is no way to know if free-time searches are accurate.

Thus, a need exists to provide an efficient way of scheduling these types of events and meetings.

### SUMMARY OF THE INVENTION

In view of the foregoing, and other, exemplary problems, drawbacks, and disadvantages of the conventional systems and methods, it is a an exemplary feature of the present invention to provide a method to improve efficiency in scheduling events that are broken down into more than one sub-event.

It is another exemplary feature of the present invention to provide a technique in which participants or audience members of an event can provide an indication that they are aware of the event and each sub-event.

It is another exemplary feature of the present invention to provide a technique in which participants or audience members of an event can provide an indication of which sub-event they will participate in.

It is another exemplary feature of the present invention to provide a technique in which an event can be managed by an agenda owner such that, during the progress of the event, participants or audience members can receive an updated event agenda that indicates progress of the event.

It is another exemplary feature of the present invention to provide a technique in which participants or audience members of an event can provide an indication that they are aware of the updated event agenda and which of the sub-events of the updated event agenda they still intend to participate in.

To achieve the above exemplary features and others, in a first exemplary aspect of the present invention, described herein is a method of electronically scheduling an event comprising one or more sub-events, including generating an event agenda for the event by identifying a sub-event agenda item for each of the sub-events, each sub-event agenda item being entered into an electronic calendar scheduler as a separately-scheduled sub-event for the event.

In a second exemplary aspect of the present invention, also described herein is an electronic calendar scheduler, including a graphical user interface (GUI) module allowing an agenda owner to generate an event agenda for an event comprising at least one sub-event, by identifying a sub-event agenda item for each sub-event. Each sub-event agenda item is entered into the electronic calendar scheduler as a separately-scheduled sub-event for the event.

In a third exemplary aspect of the present invention, also described herein is a signal-bearing medium tangibly embodying a program of machine-readable instructions executable by a digital processing apparatus to perform at least a portion of a process related to the above-described method of electronically scheduling an event comprising one or more sub-events. The program of machine-readable instructions includes instructions for at least one of: a graphical user interface (GUI) module allowing an agenda owner to generate an event agenda by entering an agenda item for each sub-event; a memory module allowing an event agenda for one of the events to be entered into and retrieved from a memory, where the event agenda includes sub-event agenda items each separately enterable as a scheduled sub-event on an electronic calendar scheduler; a communications module to transmit, to each of invited attendees to one of the events, an event agenda including the sub-event agenda items separately enterable as a scheduled sub-event on an electronic calendar scheduler; a communications module to receive, from invited attendees to one of the events, an indication as to which separately enterable sub-events of the event the invited attendee would attend; a graphical user interface (GUI) module allowing an agenda owner to generate an updated event agenda for one of the events, the updated event agenda generated by identifying as an input into the electronic calendar scheduler at least one of a beginning and a completion of one or more of the sub-events as the event progresses; and a communications module to transmit, to each of invited attendees to one of the events, an updated event agenda identifying at least one of a beginning and a completion of one or more of the sub-events as the event progresses.

In a fourth exemplary aspect of the present invention, also described herein is a method for an electronic calendar scheduling service that includes electronically providing an entry into a user's electronic calendar scheduler for an event comprising at least one sub-event, wherein the entry for the event into the user's electronic calendar scheduler comprises entering at least one separately-scheduled sub-event of the event.

Thus, by allowing each sub-event to be separately tracked on a scheduler, the present invention provides an improved method of calendaring events that have more than one sub-event.

### BRIEF DESCRIPTION OF THE DRAWINGS

The foregoing and other exemplary features, aspects and advantages will be better understood from the following detailed description of an exemplary embodiment of the invention with reference to the drawings, in which:

FIG. 1 illustrates an exemplary flowchart 100 for creating an agenda using the agenda-based event scheduler of the present invention;

FIG. 2 illustrates an exemplary flowchart of a meeting attendee's alternatives 200 upon receipt of the agenda;

FIG. 3 illustrates an exemplary flowchart 300 of managing an agenda-based meeting;

FIG. 4 exemplarily illustrates an entry into the agenda-based scheduling feature, as implemented with a graphical user interface (GUI) 400 of a calendar system that incorporates the present invention;

FIG. 5 exemplarily illustrates entry into the editing stage of the agenda-based scheduling feature, using GUI display 500;

FIG. 6 exemplarily illustrates an edit process of the agenda-based scheduling feature, using GUI display 600;

FIG. 7 illustrates an exemplary block diagram 700 of the agenda-based meeting system of the present invention;

FIG. 8 illustrates an exemplary hardware/information handling system 800 for incorporating the present invention therein; and

FIG. 9 illustrates a signal bearing medium 900 (e.g., storage medium) for storing steps of a program of a method according to the present invention.

### DETAILED DESCRIPTION OF EXEMPLARY EMBODIMENTS OF THE INVENTION

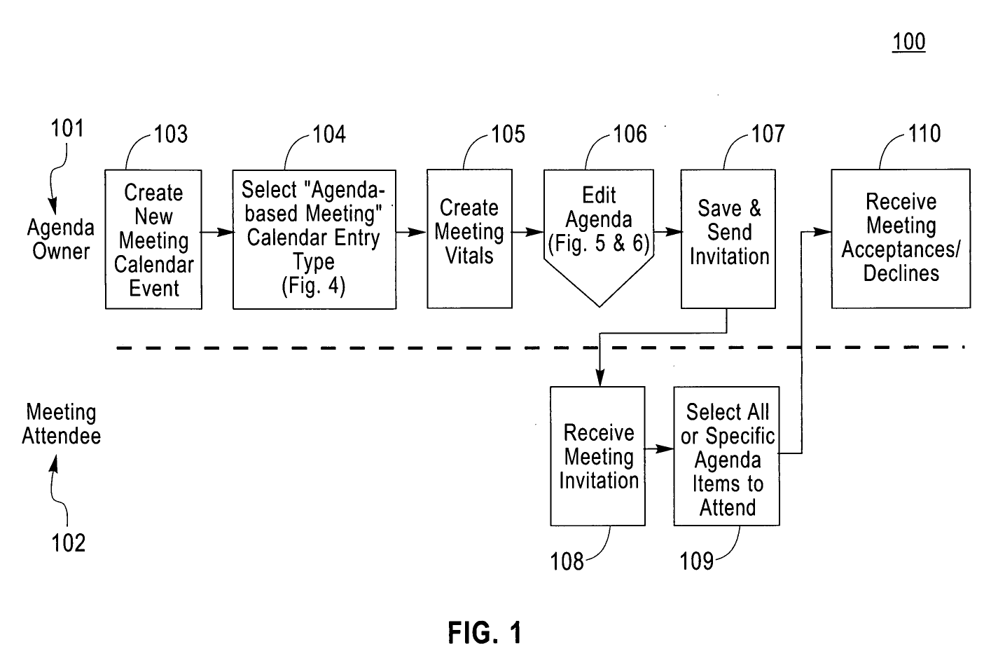

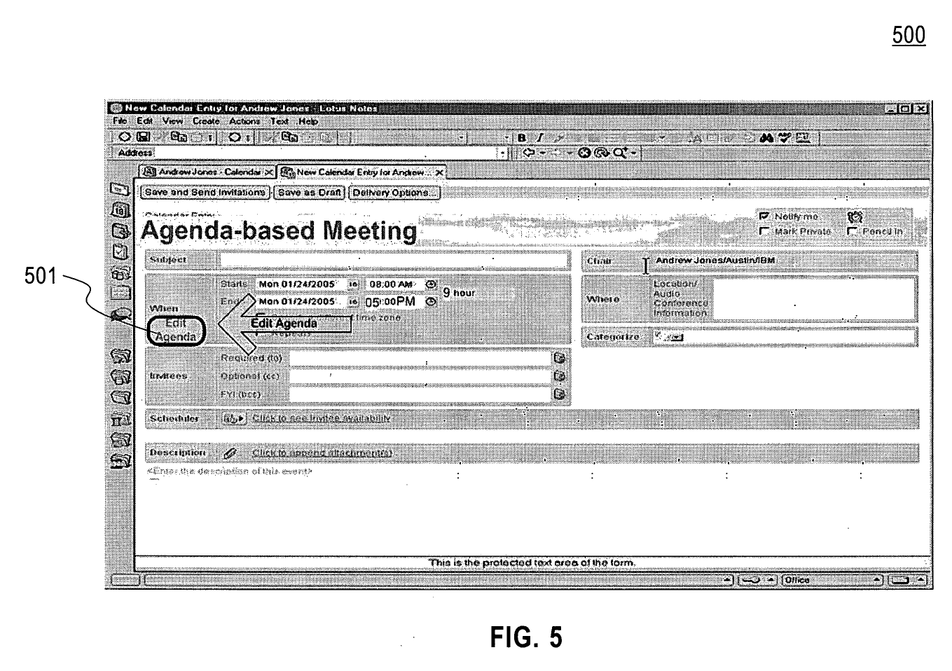

Referring now to the drawings, and more particularly to FIGS. 1-9, exemplary embodiments of the present invention will now be described.

It is noted that one of ordinary skill in the art, after having read the details described herein, would readily be able to apply the present invention in other ways than discussed below, as a system and method for creating calendar events with logical sub-events such that invitees can accept or decline each sub-event individually. The system, therefore, allows for more finely-tuned control of a calendar and supports real scenarios not possible with conventional methods.

Although the concepts of the present invention are discussed in terminology of a meeting, it will be readily recognized by one of ordinary skill in the art, after taking the following discussion as a whole, that the present invention has broader application than simply a meeting agenda. Thus, any event that can be broken down into a schedule of sub-events and that involve multiple participants can benefit from the concepts of the present invention, such as but, of course, not limited to such events as medical or other types of appointments and entertainment or sporting events, etc.

Further, as explained shortly, the system allows for significant automated sub-event management controls to the meeting owner(s), such that required and optional invitees can be notified of sub-event (agenda) changes within the overall meeting agenda, through a variety of means, including such mechanisms as Instant Messaging, SMS (Short Message Service), automated dial-out functions, and email.

The “agenda-based” calendaring of the present invention allows entry creators to identify required and optional attendees, based upon a meeting agenda/schedule, and not just an all-day event. Intelligent acceptance handling is also disclosed that allows individuals identified as required only for certain parts of the agenda to block only those times on the calendar, to block the entire day (traditional all day event), or to add additional blocks of the agenda to his/her calendar unless marked as “private” by the creator.

In addition, the present invention describes an intelligent notification system that can be integrated with any conventional messaging system (e.g., email, IM, SMS, etc.) to allow meeting owners/moderators to dynamically notify participants that portions of the agenda are running over in time, or may be starting early, or have been postponed or even deleted from the agenda.

This approach offers significant advantages over conventional methods of scheduling all-day meetings.

For example, busy executives and meeting participants will be able to accurately maintain their calendar, thereby allowing other calendar tools to be more effective in scheduling. In addition, by using an HTML (HyperText Markup Language) export of the dynamic calendar event, web pages can readily be kept up-to-date with the current status of the meeting and how the agenda is progressing. This system can also be integrated with automated dialing systems or automated notification systems to call or message participants at particular times, based upon the real-time progress of the agenda.

The method of the agenda-based scheduling of the present invention can be viewed as including two stages: agenda event creation and agenda event management, as summarized below.

1. Agenda Event Creation

describes calendar events based upon a meeting agenda and a method to logically segment the calendar event based on that information

allows meeting creators to identify required and optional attendees for all or parts of the meeting event based upon the agenda

allows meeting creators to mark certain agenda items as private

allows calendar owners to accept or decline each logical segment (agenda item) of the calendar separately

ability to put notes associated with individual agenda items and store in calendar event (include import and export capability)

2. Agenda Event Management

provides a method for the meeting agenda entered into the calendar to be exported to a typical agenda page for word processor (Word® or text editor) or presentation tools (e.g., PowerPoint®). It is noted that, although the following items are described in the context of being implemented within a calendar tool (e.g., Lotus Notes™), it is also readily implemented in other programs, such as an Instant Messaging system or an e-meeting tool or a stand-alone program. The present invention is intended as covering all these expansive possibilities and is not intended as being limited to calendar tool implementations.

dynamically manages the agenda through the calendar tool (set new start/stop times for individual agenda items)

integrates Instant Messaging into calendar events such that the event creator can send instant messages to various attendees or group of attendees about changes of schedule (agenda item running long or short) or to queue them up to dial-in and get ready to participate

automates instant messaging based upon updates to agenda, as the meeting moves forward a “completed” button can be pressed for each agenda line item and messages can be distributed to upcoming agenda item participants. By using existing instant messaging systems, users can respond to the agenda owner that they are dialing in, have a problem getting in, or have other problems related to responding.

FIGS. 1-3 show exemplary flowcharts of the present invention and 4-6 exemplarily demonstrate various of the steps described in the flowcharts.

FIG. 1 shows the basic process 100 of setting up the agenda-based scheduling in flowchart form and separates by the dotted line those steps related to the agenda owner 101 and those related to the meeting attendee 102. Relative to the present invention, the agenda owner 101 is the creator of the event and owns the rights to edit and delegate rights to the event and its sub events. This creation creates the event and subevents, along with associated attributes, such as required attendees, optional attendees, start/stop times, etc.

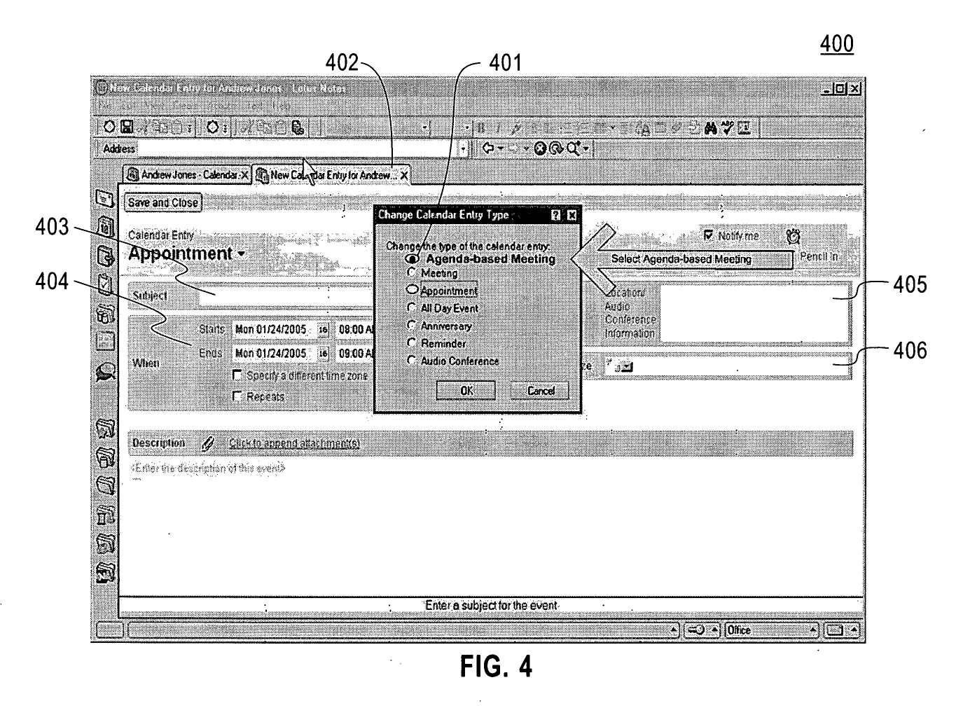

In step 103, the agenda owner 101 begins creating a new meeting calendar event by, for example, accessing a calendar tool that includes the agenda-based scheduling method of the present invention as one of its features, such as Lotus Notes™. FIG. 4 shows an example of the GUI display 400 for this calendar system.

As demonstrated in FIG. 4, in step 104, the agenda owner 101 clicks on “Agenda-based Meeting” 401 to gain entry to the agenda-based scheduling. The user arrived at this page by selecting the “New Calendar Entry” tab 402 at the top of the display 400.

In step 105, the agenda owner 101 enters vital data for the meeting, such as subject 403, time 404, location 405, and category 406.

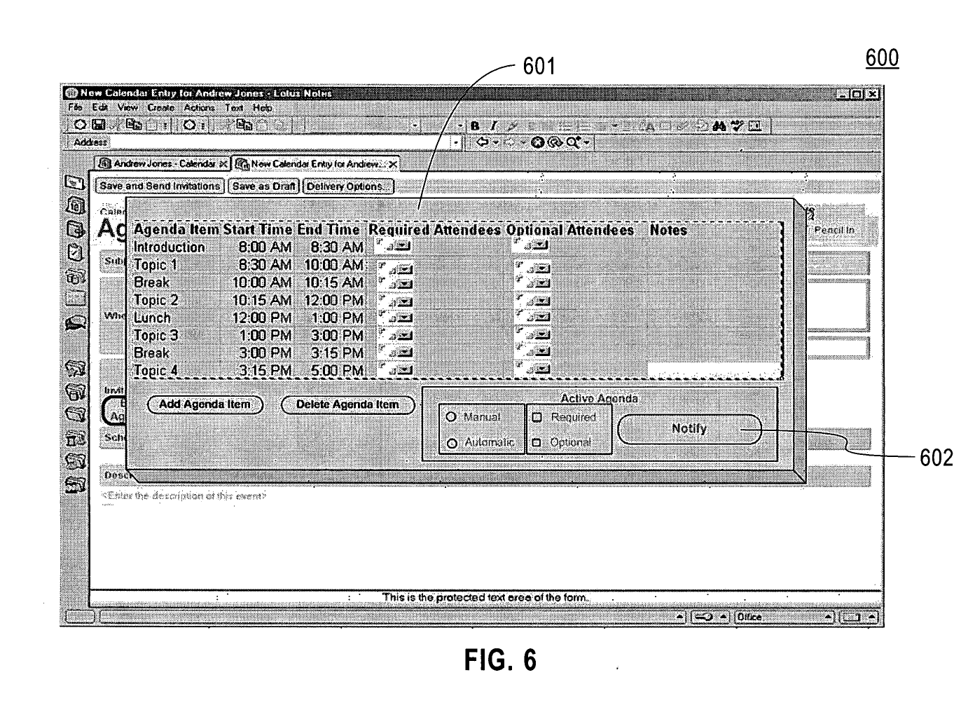

In step 106, the agenda owner 101 is able to edit the agenda by selecting “Edit Agenda” 501, which automatically appears when the agenda owner selects “Agenda Based Meeting” icon 401 shown in FIG. 4. FIG. 6 shows a GUI display 600 with a completed agenda 601.

In step 107, the agenda owner 101 is able to save the completed agenda 601 and sends invitations by transmitting the agenda to meeting attendees 102, using “Notify” 602.

In steps 108 and 109, meeting attendees 102 respectively receive the invitation and select agenda items to attend. This selection action places these agenda items onto the calendar of the respective meeting attendee 102 and transmits back an acknowledgement so that agenda owner 101 is aware in step 110 that the meeting attendee 102 received the invitation and will either accept or decline the meeting.

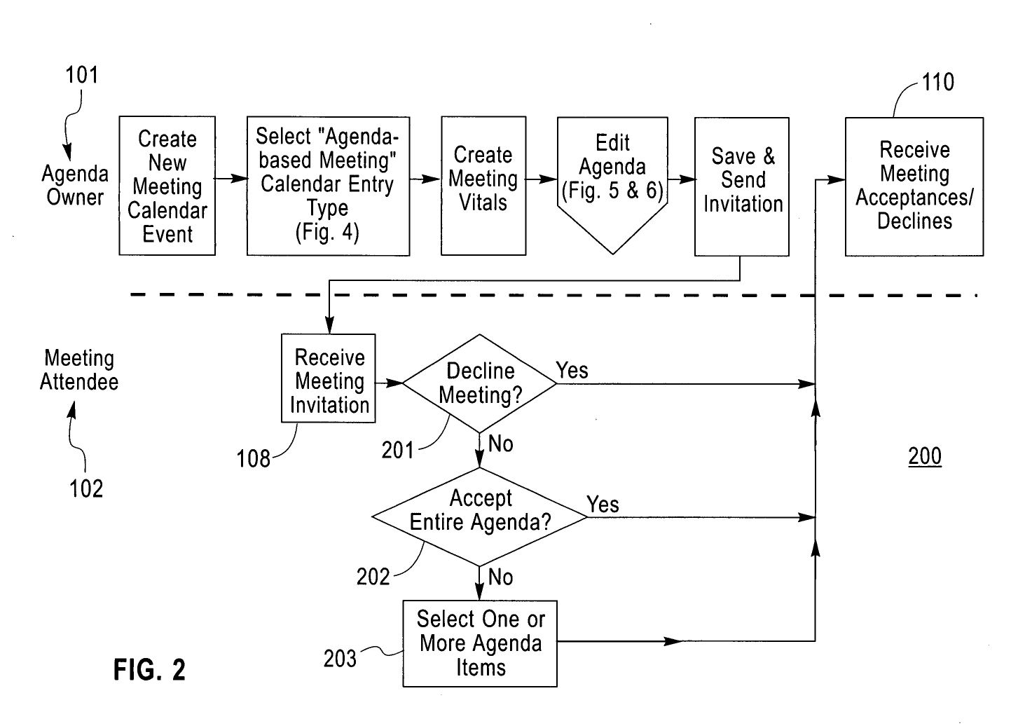

FIG. 2 shows the alternative actions 200 of the meeting attendee 102 in which the attendee can accept/decline 201, accept the entire agenda 202, or select only agenda items of interest 203.

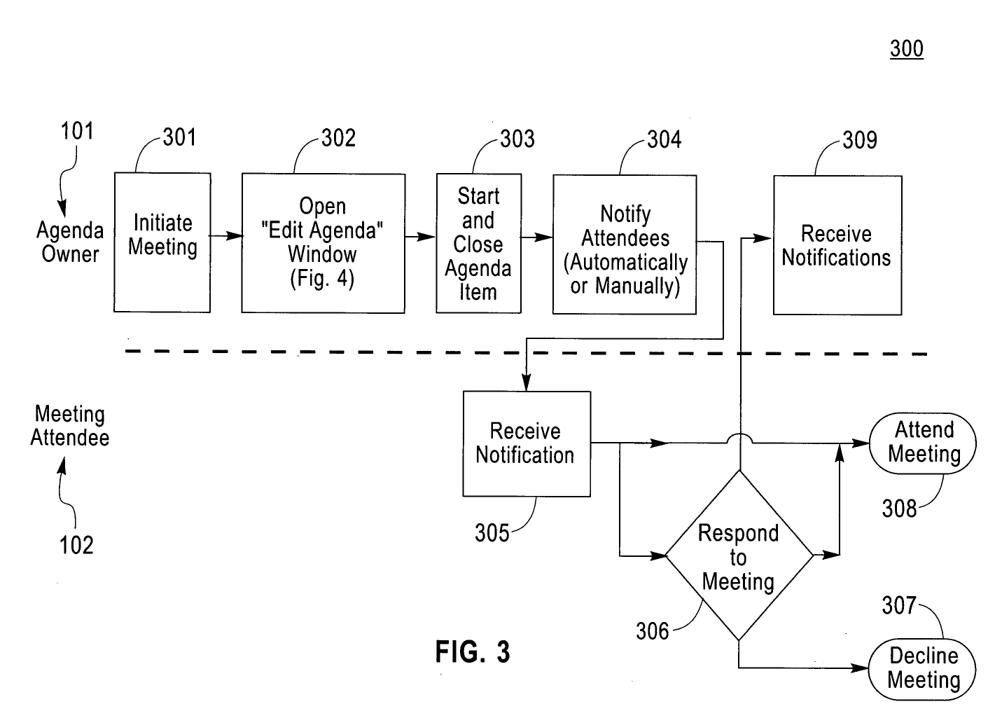

FIG. 3 exemplarily illustrates the process 300 of managing a previously scheduled meeting in which, in step 301, the agenda owner 101 initiates the meeting by opening the “Edit Agenda” window in step 302.

In step 302, the agenda owner 101 starts and closes each agenda item as appropriate.

In step 304, the agenda progress is transmitted to meeting attendees 102, either automatically or manually, again using “Notify” 602 shown in FIG. 6.

In step 305, meeting attendees 102 respectively receive the agenda update notifications and, in step 306, provide indications back to agenda owner 101 that meeting attendee 102 will decline the meeting 307, attend the meeting 308, and has been notified 309.

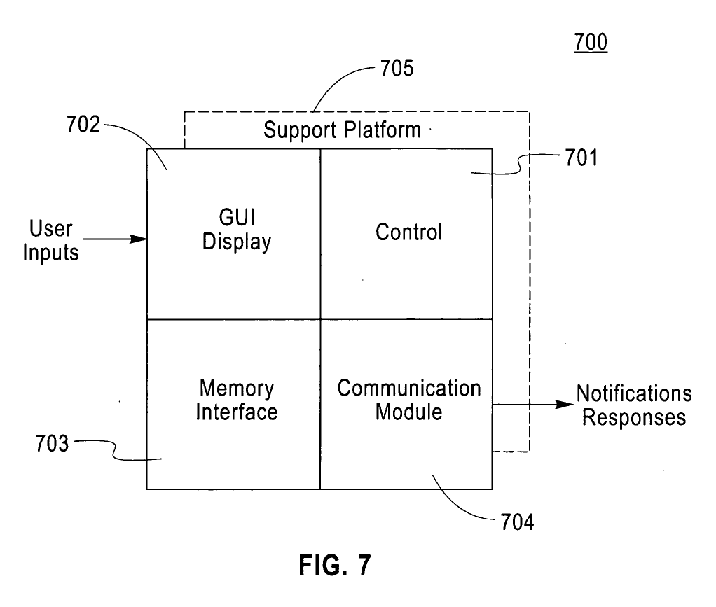

FIG. 7 shows an exemplary block diagram 700 of the various modules comprising the present invention. Control module 701 provides the overall control instructions for the operation. GUI Display module 702 provides the displays discussed above for the system and a means to interact with users (e.g., the agenda owner 101 and meeting attendees 102).

Memory interface 703 provides the interface with memory to save the agenda during its lifetime, as well as provide the storage of the program of instructions that comprise the software modules of the agenda-based scheduler.

Communications module 704 provides the interface to any of possible communications systems used to transmit agenda-related notifications and meeting attendee 102 responses.

As mentioned previously, the present invention might be incorporated in a support platform 705 such as an existing calendar scheduling system or might be a standalone system.

Although the exemplary embodiment was described as a meeting of multiple invited attendees who plan to be present as participants or observers, the present invention has variations that are intended as included in a more general concept.

Thus, for example, an invited attendee might be someone who is invited to aware of the meeting or event so that person could remotely listen or otherwise monitor progress of the meeting or event. Moreover, the invited attendee might be someone who will participate by telephone, video conferencing, or other remote participatory mechanism.

The event might not be a business meeting, but rather some other business-related event, such as an appointment for a service, or even a non-business event, such as a personal meeting or other scheduled personal event of interest to the user.

Additionally, it is not necessary that each invited attendee have an individual electronic calendar scheduler. Thus, for example, the sub-events could be stored in an electronic calendar scheduler that is accessible to more than one invited attendee.

Along this line, as another non-limiting variation, the present invention might also be used in environments totally unrelated to the business world. Thus, for example, participants or audiences of entertainment or sporting events could also benefit from application of the present invention. Each participant or audience member may have access to a centralized electronic calendar scheduler that sends out updates as the event proceeds, rather than having individual electronic calendar scheduler for each participant or audience member.

For example, the technique of the present invention might be utilized as a distributed agenda for a sporting event, such as the Olympic games or a national tournament, in which members of the viewing public are constantly advised of the latest events and results of events and games and who proceeds to the next higher level of competition. Such wide-spread agenda distribution would, for example, be accessible as a service via the Internet by viewing members of the public, thereby allowing the present invention to serve as the basis of a service oriented to providing event calendaring service to clients.

Exemplary Hardware Implementation

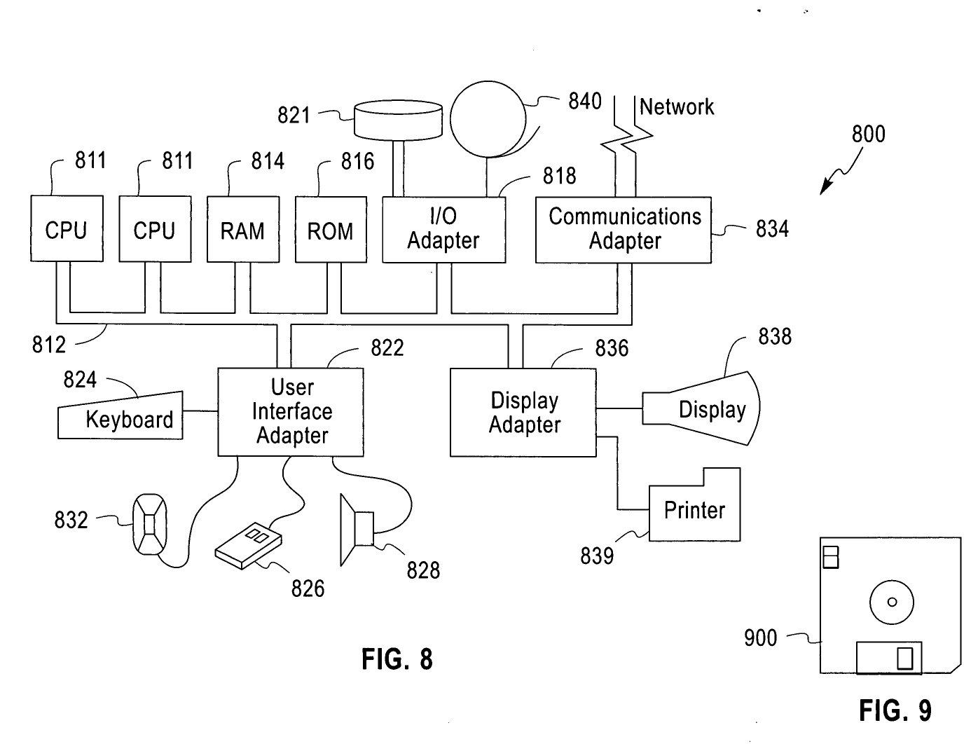

FIG. 8 illustrates a typical hardware configuration of an information handling/computer system in accordance with the invention and which preferably has at least one processor or central processing unit (CPU) 8711.

The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described our invention, what we claim as new and desire to secure by Letters Patent is as follows:

1. A method of electronically scheduling an event, said event comprising at least one sub-event, said method comprising:
generating an event agenda for said event by identifying a sub-event agenda item for each said sub-event, each said sub-event agenda item being entered into an electronic calendar scheduler as a separately-scheduled sub-event for said event.

2. The method of claim 1, further comprising:
notifying each of invited attendees to said event by transmitting said event agenda to each said invited attendee, each said invited attendee receiving said event agenda able to selectively enter each said sub-event agenda item into an electronic calendar scheduler as a separately scheduled entity.

3. The method of claim 2, further comprising:
said invited attendees respectively returning an acknowledgment to an agenda owner who generated said event agenda that said event agenda was received.

4. The method of claim 2, further comprising:
each said invited attendee selectively returning a response to an agenda owner who generated said event agenda as to which, if any, sub-events said invited attendee will attend.

5. The method of claim 1, further comprising:
using said event agenda for managing said event by identifying as an input into said electronic calendar scheduler at least one of a beginning and a completion of one or more of said sub-events.

6. The method of claim 5, further comprising:
notifying each of invited attendees to said event of a progress of said event by transmitting to each said invited attendee an updated event agenda that reflects a progress of said event.

7. The method of claim 6, further comprising at least one of:
said invited attendees respectively and selectively returning an acknowledgment to an agenda owner who generated said event agenda that said updated event agenda was received; and
each said invited attendee selectively returning a response to said agenda owner as to which, if any, sub-events said invited attendee will attend.

8. The method of claim 6, wherein said notifying is selectively one of a manual notification and an automatic notification.

9. An electronic calendar scheduler, comprising:
a graphical user interface (GUI) module allowing an agenda owner to generate an event agenda for an event, said event comprising at least one sub-event, by identifying a sub-event agenda item for each said sub-event, each said sub-event agenda item being entered into said electronic calendar scheduler as a separately-scheduled sub-event for said event.

10. The electronic calendar scheduler of claim 9, further comprising:
a communications module to transmit said event agenda to each of invited attendees to said event, each said invited attendee receiving said event agenda able to selectively enter each said sub-event agenda item into an electronic calendar scheduler as a separate scheduled entity.

11. The electronic calendar scheduler of claim 10, wherein said communications module receives responses from said invited attendees, each said response selectively sent by one of said invited attendees and comprising an indication from said responding invited attendee of at least one of:
said responding invitee has received said event agenda; and
which, if any, of said sub-events said responding invitee plans to attend.

12. The electronic calendar scheduler of claim 9, wherein said GUI module further allows said agenda owner to generate an updated event agenda for said event as said event progresses.

13. The electronic calendar scheduler of claim 10, wherein said GUI module further allows said agenda owner to generate an updated event agenda for said event as said event progresses and said communications module selectively transmits said updated event agenda to said invited attendees.

14. A signal-bearing medium tangibly embodying a program of machine-readable instructions executable by a digital processing apparatus to perform at least a portion of a process related to a method of electronically scheduling an event comprising one or more sub-events, said method comprising generating an event agenda for said event by identifying a sub-event agenda item for each said sub-event, each said sub-event agenda item capable of being entered into an electronic calendar scheduler as a separately-scheduled sub-event for said event, said program of machine-readable instructions comprising instructions for at least one of:
a graphical user interface (GUI) module allowing an agenda owner to generate said event agenda for said event by entering an agenda item for each said sub-event, each said sub-event agenda item being entered into said electronic calendar scheduler by said agenda owner as a separately-scheduled sub-event for said event;
a memory module allowing an event agenda for one of said events to be entered into and retrieved from a memory, said event agenda comprising sub-event agenda items each separately enterable as a scheduled sub-event on an electronic calendar scheduler;
a communications module to transmit, to each of invited attendees to one of said events, an event agenda comprising said sub-event agenda items each separately enterable as a scheduled sub-event on an electronic calendar scheduler;
a communications module to receive, from invited attendees to one of said events, an indication as to which separately enterable sub-events of said event said invited attendee would attend;
a graphical user interface (GUI) module allowing an agenda owner to generate an updated event agenda for one of said events having an agenda item for each said sub-event entered into said electronic calendar scheduler as a separately-scheduled sub-event for said event, said updated event agenda generated by identifying as an input into said electronic calendar scheduler at least one of a beginning and a completion of one or more of said sub-events as said event progresses; and
a communications module to transmit, to each of invited attendees to one of said events, an updated event agenda comprising said sub-event agenda items each separately enterable as a scheduled sub-event on an electronic calendar scheduler, said updated event agenda generated by identifying as an input into said electronic calendar scheduler at least one of a beginning and a completion of one or more of said sub-events as said event progresses.

15. The signal-bearing medium of claim 14, wherein said signal-bearing medium comprises one of:
a stand-alone diskette containing one or more of said modules, said stand-alone diskette to be loaded into a computer drive;
a memory in a server on a network, said server transmitting one or more of said modules to a user in response to a request;
a hard drive on a computer containing one or more of said modules; and
a program memory on a computer currently executing one or more of said modules.

16. The signal-bearing medium of claim 14, wherein said event comprises one of:
a meeting;
a business meeting;
a business event;
an entertainment event; and
a sporting event.

17. A method for an electronic calendar scheduling service, said method comprising:
electronically providing an entry into a user's electronic calendar scheduler for an event comprising at least one sub-event, wherein said entry for said event into said user's electronic calendar scheduler comprises entering at least one separately-scheduled sub-event of said event.

18. The method of claim 17, wherein said entry for said event is dynamically updated as said event occurs.

19. The method of claim 17, wherein said electronically providing of said entry into said user's electronic calendar scheduler comprises a downloading through a computer network.

20. The method of claim 17, wherein said event comprises one of:
a meeting;
a business meeting;
a business event;
an entertainment event; and
a sporting event.
